(19) United States
(12) Patent Application Publication
(10) Pub. No.: US 2013/0076198 A1
(43) Pub. Date: Mar. 28, 2013

(54) ROTOR FOR ELECTRIC ROTATING MACHINE AND METHOD FOR MANUFACTURING THE SAME

(71) Applicants: Takashi ASAGA, Toyota-shi (JP); Toshiya SUGIYAMA, Okazaki-shi (JP)

(72) Inventors: Takashi ASAGA, Toyota-shi (JP); Toshiya SUGIYAMA, Okazaki-shi (JP)

(73) Assignee: AISIN SEIKI KABUSHIKI KAISHA, Kariya-shi (JP)

(21) Appl. No.: 13/604,102

(22) Filed: Sep. 5, 2012

(30) Foreign Application Priority Data
Sep. 24, 2011 (JP) 2011-208280

(51) Int. Cl. H02K 1/28; B21D 53/78

(52) U.S. Cl. 310/216.116; 29/889

(57) ABSTRACT

A rotor for an electric rotating machine includes a core body member formed with laminated core plates and a pair of end plates sandwiching opposing ends of the core body member. An output member is connected to an inner peripheral portion of one of the end plates with a connecting member. A first through-hole for allowing an insertion of the connecting member is press formed from the direction opposite to the direction outer and inner peripheral portions of the one of the end plates are press formed. Shear-droops formed at the outer and the inner peripheral portions of the one of the end plates during the press forming are arranged on the surface opposite to the surface thrusting the core body member. A shear-droop formed at the first through-hole during the press forming is arranged on the surface of the one of the end plates thrusting the core body member.

### CROSS REFERENCE TO RELATED APPLICATIONS

This application is based on and claims priority under 35 U.S.C. §119 to Japanese Patent Application 2011-208280, filed on Sep. 24, 2011, the entire content of which is incorporated herein by reference.

### TECHNICAL FIELD

This disclosure generally relates to a rotor for an electric rotating machine and methods for manufacturing the same.

### BACKGROUND DISCUSSION

A patent reference JP2008-289329A, hereinafter referred to as Patent reference 1, discloses a rotor for an electric motor in which a rotor core is retained with a pair of end plates. The rotor core is formed with a multiple number of electromagnetic steel sheets being stacked one on top the other and the pair of end plates sandwiching opposing ends of the rotor core in the direction in which the rotor core is being stacked one on top the other. A pin is inserted through the rotor core and through the pair of end plates. Opposing ends of the pin are riveted so that the rotor core is retained with the pair of end plates. Outer peripheral portion of each of the end plates is formed with a tapered portion. The tapered portion thrusts the rotor core when the opposing ends of the pin inserted through the end plates are riveted, so that the end plates retain the rotor core rigidly.

Variations of the rotor for the electric motor being disclosed in Patent reference 1 are available. In an example of the rotor for the electric motor, inner peripheral portions of the end plates connect with an output member where the rotation of the rotor is being transmitted. In most cases, the output member is connected with one of the pair of end plates that retains the rotor core. The end plate being connected with the output member is provided with a pressing portion for retaining the rotor core and a connecting portion that extends inward in a radial direction from the pressing portion. The connecting portion is provided with a through-hole for inserting an attaching bolt. In a state where a surface of the end plate that thrusts the rotor core being in contact with the output member, the output member and the rotor are connected by inserting the attaching bolt through the through-hole for inserting the attaching bolt from the side of the end plate to the output member and by tightening the attaching bolt thereat.

When the electric motor is operated, rotation of the rotor produces a centrifugal force. As a result, a structure connecting the end plate and the output member receives a large load. In order to withstand the load, the attaching bolt for connecting the end plate and the output member is tightened to the output member with an axial force equal to or greater than the predetermined amount. When tightening the attaching bolt, the end plate receives a predetermined load from a head portion of the attaching bolt. Accordingly, a portion on the end plate in a periphery of the through-hole for inserting the attaching bolt is provided with strength for withstanding the load applied from the head portion of the attaching bolt. The through-hole for inserting the attaching bolt that extends through the end plate is press formed with a press machine by punching a plate member in a thickness direction. Accordingly, a shear-droop is formed on an edge portion of the through-hole for inserting the attaching bolt, the edge portion on a surface of the plate member where a punch has penetrated first. The shear-droop is a result of forming the through-hole for inserting the attaching bolt through a press forming process where the edge portion of the inner peripheral surface of the through-hole becomes rounded instead of being an edge substantially perpendicular to the surface of the plate member where the punch is entered. When the attaching bolt is inserted to the through-hole for inserting the attaching bolt from the surface of the end plate where the shear-droop is formed, the end plate receives the load being generated by the head portion of the attaching bolt thrusting the end plate with a reduced surface area. Accordingly, an excessive stress may be generated on the end plate in the peripheral portion of the through-hole for inserting the attaching bolt. As a result, a state of the attaching bolt being tightened may become loose as a result of a partial deformation of the end plate in the peripheral portion of the through-hole for inserting the attaching bolt.

In order to prevent the attaching bolt from becoming loose, a material for forming the end plates may be replaced with a material of higher rigidity. Nevertheless, the material of higher rigidity may provide a processing difficulty or may increase cost of manufacturing. In order to provide an appropriate surface area of contact for the head portion of the attaching bolt against the surface where the head portion of the attaching bolt makes contact, the shear-droop may be reduced by shaving or a similar process, however, shaving adds a process to the manufacturing process, which may result in increasing the manufacturing cost. A need thus exists for a rotor for an electric rotating machine and a method for manufacturing the same, which are not susceptible to the drawback mentioned above.

### SUMMARY

According to an aspect of this disclosure, a rotor for an electric rotating machine includes a core body member formed with a plurality of core plates being stacked one on top the other in an axial direction along a rotational axis, a pair of end plates sandwiching opposing ends of the core body member in the direction which the core body member is being stacked one on top the other, and an output member connected to at least one of the end plates. Said at least one of the end plates includes a contact portion configured to thrust the core body member, a connecting portion extending from the contact portion toward the rotational axis, the connecting portion provided with a first through-hole for allowing an insertion of a connecting member, the connecting member that connects said at least one of the end plates and the output member, a first surface being continuous with a rounded surface portion formed during a process for forming the first through-hole, and a second surface being provided on a reverse side of the first surface. Said at least one of the end plates is formed by press forming a plate member in thickness directions, a first direction for forming an outer peripheral end portion of said at least one of the end plates and a second direction, the direction different from the first direction, for forming the first through-hole provided on said at least one of the end plates. The first surface of said at least one of the end plates faces a surface of the core body member and a surface of the output member, and the second surface of said at least one of the end plates makes contact with a surface of the connecting member.

According to another aspect of this disclosure, a method for manufacturing a rotor for an electric rotating machine includes a process of forming a core body member by stacking a plurality of core plates one on top the other in an axial direction along a rotational axis. The method for manufacturing the rotor for the electric rotating machine also includes processes of forming an intermediate member by press forming a plate member from a first direction for forming a second through-hole for allowing an insertion of a fastening pin and forming at least one of end portions including a rounded surface portion, and of forming at least one of a pair of end plates, which includes a contact portion provided with a first surface configured to thrust the core body member and includes a connecting portion extending toward the rotational axis from the contact portion, the connecting portion provided with a first through-hole for allowing an insertion of a connecting member, formed by forming the first through-hole by press forming the intermediate member from a second direction different from the first direction, the second direction which is the direction from the first surface provided on the reverse side of a second surface, the second surface being continuous with the rounded surface portion. The method for manufacturing the rotor for the electric rotating machine further includes processes of connecting the core body member and the end plates by riveting the fastening pin inserted through the second through-hole extending through each of the end plates and through the core body member in a state where the first surface thrusts a corresponding end surface of the core body member, and of connecting the core body member, the end plates and the output member by inserting the connecting member through the first through-hole in a state where the output member is in contact with the first surface of the connecting portion and by tightening the connecting member thereat.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a cross-sectional view of an electric motor according to a first embodiment in a state of being installed to a vehicle;

FIG. 2 is an enlarged cross-sectional view of an end plate of the rotor being connected to a drum member of the electric motor that is illustrated in FIG. 1;

FIG. 3 is a partial cross-sectional view illustrating a process for forming the end plate that is illustrated in FIG. 2 before forming an outer peripheral end, an inner peripheral end, and a through-hole for allowing an insertion of a fastening pin;

FIG. 4 is a partial cross-sectional view illustrating a process for forming the end plate where the outer peripheral end, the inner peripheral end, and the through-hole for allowing the insertion of the fastening pin are formed;

FIG. 5 is a partial cross-sectional view illustrating a process for forming the end plate before forming a through-hole for allowing an insertion of a connecting bolt;

FIG. 6 is a partial cross-sectional view illustrating a process for forming the end plate where the through-hole for allowing the insertion of the connecting bolt is formed; and

FIG. 7 is a schematic drawing showing the electric motor according to applicable embodiments and devices in the periphery of the electric motor.

### DETAILED DESCRIPTION

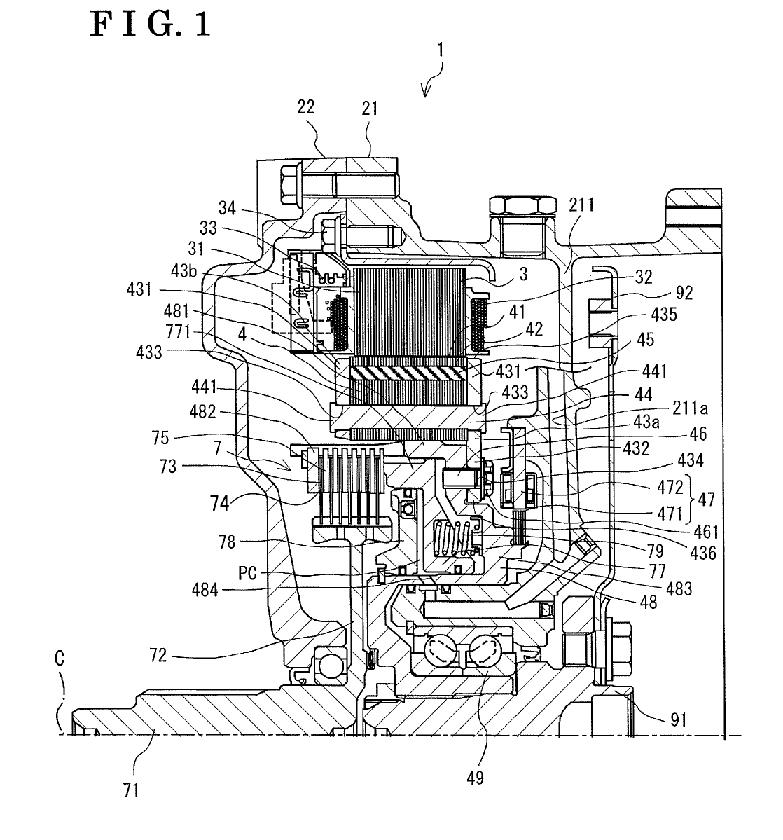

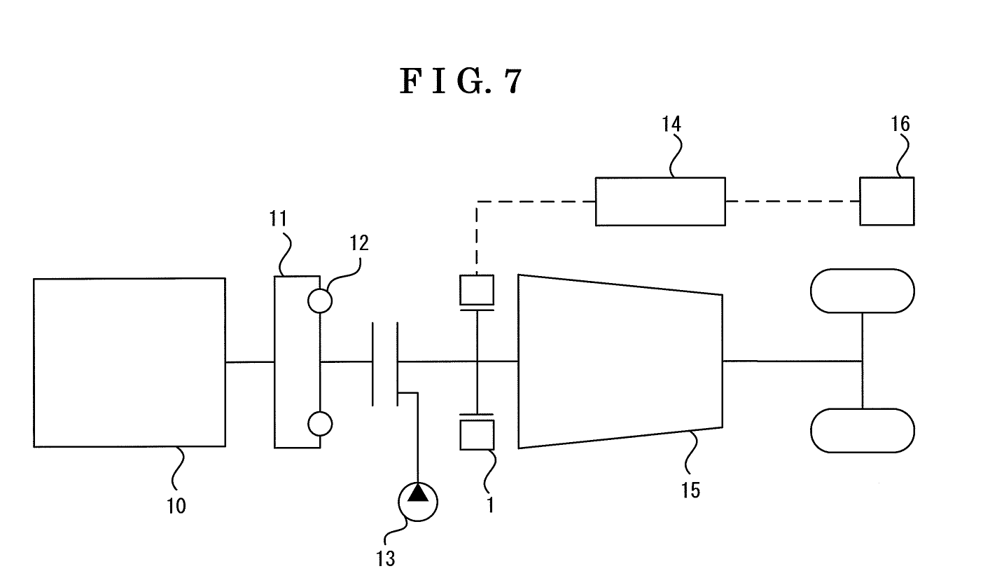

A rotor 4 for an electric motor 1 according to a first embodiment will be described as follows with references to FIGS. 1 to 7. A clutch device 7 that connects with the rotor 4 will be described as necessary. The electric motor 1, which serves as an electric rotating machine, according to the first embodiment is a synchronous motor for driving wheels of a hybrid vehicle. The electric motor 1 is disposed between the clutch device 7, which is connected to an engine 10, and a transmission 15. Nevertheless, applications of the electric motor 1 disclosed here are not limited to such and may be applied to limitless types of electric motors, for example, a motor adapted for household appliances or a motor adapted for driving a general industrial machinery. For a purpose of description, a rotational axis direction, an axial direction, or similar expression refers to a direction along a rotational axis C of the electric motor 1, which is shown in right and left directions of FIG. 1, unless otherwise described. In addition, a left direction of FIG. 1 is referred to as a frontward direction of the electric motor 1 and the clutch device 7 and a right direction of FIG. 1 is referred to as a rearward direction of the electric motor 1 and the clutch device 7.

As FIG. 1 illustrates, a motor housing 21, which is formed in one piece with an aluminum alloy or a similar material, is sealed with a motor cover 22 from the frontward direction, such that in a state where a stator 3 and the rotor 4 of the electric motor 1 are built-in. In the frontward direction of the motor cover 22, the engine 10 is attached. In the rearward direction of the motor housing 21, the transmission 15 is arranged. The clutch device 7, which is a wet-type multiple disc clutch, is disposed between the rotor 4, which is a component of the electric motor 1, and the engine 10. The clutch device 7 rotates with the rotational axis C, which is the rotational axis of the engine 10, the electric motor 1, and the transmission 15.

An input shaft 71 is connected to a flywheel 11 of the engine 10 via a damper 12. On the outer peripheral surface of the input shaft 71, a clutch inner portion 72 configured to form the clutch device 7 is formed, such that a driving force from the engine 10 may be transmitted as an input to the clutch inner portion 72. The motor cover 22 supports the clutch inner portion 72 with a bearing, so that the clutch inner portion 72 may rotate relative to the motor cover 22. A multiple number of driving discs 73 engage with the outer peripheral surface of the clutch inner portion 72, such that each of the driving discs 73 is movable in a direction of the rotational axis C relative to the clutch inner portion 72 and rotatable with the clutch inner portion 72. Each of the driving discs 73 is provided with a frictional material 74 on each of the opposing surfaces.

The stator 3 of the electric motor 1 is attached to an inner peripheral portion of the motor housing 21 with screws 34. The stator 3 includes a multiple number of cores 31. Each of the cores 31 is wound with a coil 32 for generating a rotating magnetic field. Each of the coils 32 is connected with an external inverter 14 via a bus ring 33. The rotor 4 of the electric motor 1 is arranged inward in a radial direction of the stator 3. The rotor 4 and the stator 3 are configured to face each other and arranged such that a predetermined spacing is maintained therebetween. The rotor 4 includes a core body member 41, which is formed with a multiple number of steel sheets 42 for stacking, which serve as core plates, being stacked one on top the other in the axial direction along the rotational axis C. In other words, the core body member 41 is formed by laminating a multiple number of steel sheets 42 for stacking in the axial direction along the rotational axis C. The core body member 41 is retained with a fastening pin 44 and a pair of end plates 43a, 43b, each of which is in a plate form, by inserting the fastening pin 44 through the core body member 41 and the end plates 43a, 43b and riveting the opposing ends of the fastening pin 44 in a state where the end plates 43a, 43b are sandwiching opposing ends of the core body member 41 in the direction which the core body member 41 is being stacked one on top the other. A multiple number of magnets 45 for providing field poles are circumferentially provided on the rotor 4.

In the electric motor 1 provided with such configuration, the revolving magnetic field is generated at the stator 3 when the coils 32 are supplied with a three phase alternating current or similar form of power source from an on-vehicle battery 16 via the inverter 14. The rotor 4 rotates relative to the stator 3 due to an attraction force and a repulsion force induced by the revolving magnetic field being generated.

The end plate 43a of the rotor 4, which is one of the pair of end plates 43a, 43b, is formed in substantially ring form. A connecting bolt 46, which serves as a connecting member, connects an inner peripheral portion of the end plate 43a and a portion of an end portion in the axial direction of a drum member 48. The drum member 48, which serves as an output member, is a component member of the rotor 4. The drum member is configured to rotate relative to the clutch inner portion 72 with the rotational axis C as center. The drum member 48 includes a cylindrical portion 481. A pressure receiving plate 482 is fixed to an end portion in the axial direction of the cylindrical portion 481. The pressure receiving plate 482 is arranged such that faces the driving disc 73, which is one of the driving discs 73 of which disposed closest to the end portion in the axial direction of the cylindrical portion 481.

A multiple number of driven plates 75, each of which is substantially ring form, are arranged at an inner peripheral surface side of the cylindrical portion 481 such that each of the driven plates 75 are movable in the direction of the rotational axis C relative to the drum member 48 and rotatable with the drum member 48. The driven plates 75 and the driving discs 73 are arranged such that each of the driven plates 75 and each of the driving discs 73 are provided alternately in the direction of the rotational axis C.

The drum member 48 is formed to extend inward in the radial direction such that the inner end portion of the drum member 48 spline fit with the turbine shaft 91 of the transmission 15. A connection member 92, which connects to a pump impeller, is attached to an end portion in the axial direction of the turbine shaft 91, so that the turbine shaft 91 and the connection member 92 may rotate integrally. As a result, a driving force from the drum member 48 may be transmitted as an input to a torque converter of the transmission 15. A retaining wall 211 of the motor housing 21 supports an inward end portion of the drum member 48 via a bearing 49. The drum member 48 is provided with a movable body 471 of a rotational position sensor 47. A detection body 472 being provided on the retaining wall 211 is arranged such that faces the movable body 471, so that the detection body 472 detects a rotational position of the rotor 4 with the drum member 48 attached.

The drum member 48 is provided with a containing portion 483 curved to form a U-shape in cross section with an open end of the U-shape facing leftward in FIG. 1. The containing portion 483 contains a plunger member 77, which is movable in the axial direction. The plunger member 77 is a substantially annular member. An inner peripheral end portion of the plunger member 77 fits to the containing portion 483 in a liquid-tight manner. A pressing portion 771 extends in the axial direction from an outer peripheral end portion of the plunger member 77. A retaining member 78 fits to the inner peripheral surface of the pressing portion 771 and to the containing portion 483 in the liquid-tight manner. The retaining member 78 is configured such that movement in a leftward direction in FIG. 1 is restricted. Surrounded by the containing portion 483, the plunger member 77, and the retaining member 78, a pressure chamber PC is formed.

As FIG. 1 illustrates, a piston spring 79 is arranged between the containing portion 483 and the plunger member 77. The piston spring 79 is in contact with a surface of the plunger member 77, the surface on the reverse side of the surface where the pressure chamber PC is formed. The piston spring 79 biases the plunger member 77 toward the retaining member 78, which is leftward in FIG. 1. The pressing portion 771 of the plunger member 77 being biased with the piston spring 79 thrusts the driving disc 73 and the driven plate 75 toward the pressure receiving plate 482.

The retaining wall 211 is provided with an oil passage 211a, which extends inward in the radial direction. The oil passage 211a extends further within the motor housing 21 in the axial direction, and then an open end of the oil passage 211a reaches the surface where the motor housing 21 and the drum member 48 contact. The drum member 48 is provided with a through-hole 484 configured to provide a communicative connection between the oil passage 211a and the pressure chamber PC. A fluid pressure is applied to the oil passage 211a from an external hydraulic pump 13. The applied fluid pressure is introduced to the pressure chamber PC via the through-hole 484.

The plunger member 77 is biased toward the retaining member 78 with the piston spring 79. As a result, each of the driving discs 73 and the driven plates 75 are pressed and retained to each other between the pressure receiving plate 482 and the plunger member 77 so that a torque may be transmitted between the driving discs 73 and the driven plates 75. In other words, a clutch device 7 is in a connected state, which is in a state where the driving discs 73 and the driven plates 75 rotate integrally, so that a driving force from the clutch inner portion 72 is transmitted to the drum member 48.

When the fluid pressure from the hydraulic pump 13 is applied to the pressure chamber PC, the piston spring 79 undergoes a deflection such that moves the plunger member 77 rightward in FIG. 1, so that the driving discs 73 and the driven plates 75 are released from the state of being pressed and retained to each other, the state due to the pressure from the pressing portion 771 being applied. In other words, the clutch device 7 shifts to a disconnected state, the state in which the transmission of driving force from the clutch inner portion 72 to the drum member 48 is discontinued.

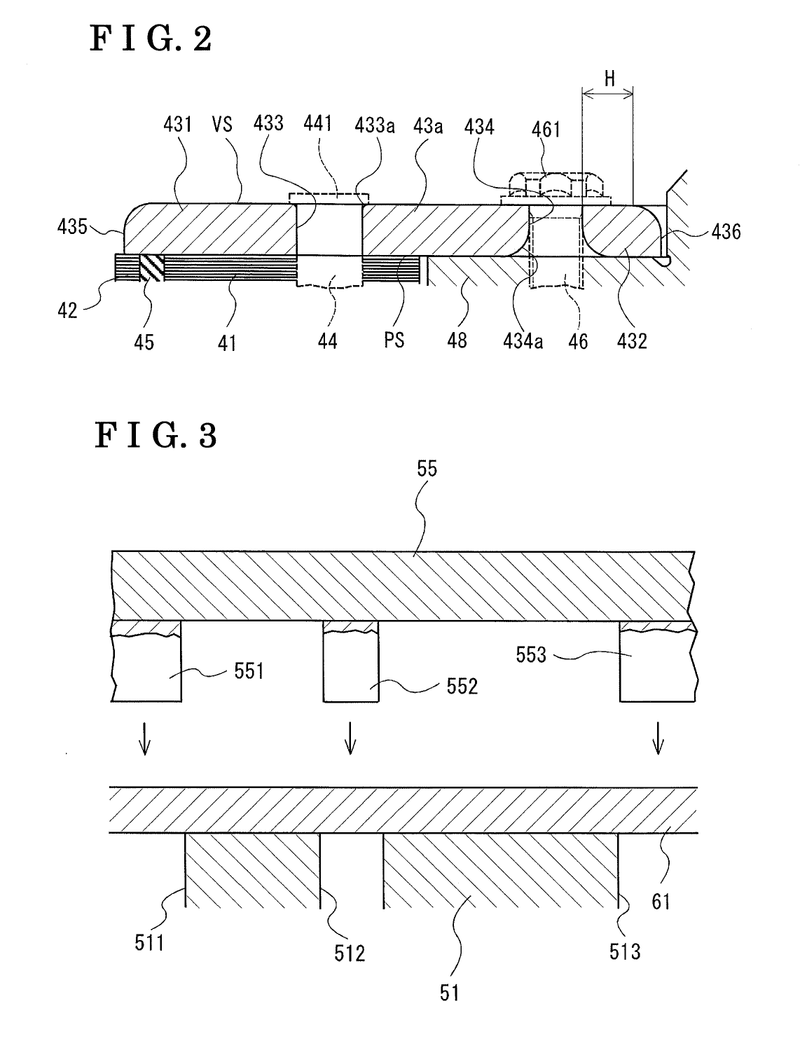

The end plate 43a, which is one of the pair of end plates 43a, 43b that connects with the drum member 48 of the electric motor 1, will be described next referring to FIG. 2. Shear-droops formed on an outer peripheral end 435, on an inner peripheral end 436, and on a through-hole 434 for inserting a connecting bolt 46 are illustrated with exaggeration in FIGS. 2 to 6, in which the shear-droops are illustrated with a larger scale. The outer peripheral end 435 serves as an outer peripheral end portion, the inner peripheral end 436 serves as an inner peripheral end portion, and the through-hole 434 for allowing the insertion of the connecting bolt 46 serves as a first through-hole for allowing an insertion of a connecting member. In FIG. 2, a surface of the end plate 43a configured to thrust the core body member 41 is referred to as a pressing surface PS, which serves as a first surface, and another surface of the end plate 43a provided on a reverse side of the surface configured to thrust the core body member 41 is referred to as a reverse side surface VS, which serves as a second surface.

As FIG. 2 illustrates, the end plate 43a is equipped with a contact portion 431 configured to thrust the core body member 41 and a connecting portion 432 projecting inward in the radial direction from the contact portion 431. In other words, the connecting portion 432 extends in the direction toward the rotational axis C from the contact portion 431. A through-hole 433 for allowing an insertion of the fastening pin 44, which serves as a second through-hole for allowing the insertion of the fastening pin extends through the contact portion 431. The through-hole 434 for allowing the insertion of the connecting bolt 46 extends through the connecting portion 432. As FIG. 2 illustrates, in a state where the pressing surface PS of the end plate 43a thrusting an end surface of the core body member 41, the fastening pin 44 is inserted through the end plate 43a, through the core body member 41, and through the end plate 43b, which is at the opposite end surface of the core body member 41, and then opposing ends of the fastening pin 44 is riveted. Accordingly, the core body member 41 is retained with the end plates 43a, 43b from the opposing ends of the core body member 41.

The end plate 43a and the drum member 48 are connected by inserting the connecting bolt 46 through the through-hole 434 for allowing the insertion of the connecting bolt 46 from the direction of the reverse side surface VS of the end plate 43a in a state where the drum member 48 is in contact with the pressing surface PS of the connecting portion 432 of the end plate 43a of which the core body member 41 is being retained, and then by tightening the connecting bolt 46 to the drum member 48. The reverse side surface VS of the end plate 43a is in contact with an underside surface of a head portion 461 of the connecting bolt 46, which serves as a surface of the connecting member. The connecting bolt 46 is inserted from the direction of the reverse side surface VS in a state where the drum member 48 is in contact with the pressing surface PS, in order to avoid a large structural change of the electric motor 1 and the clutch device 7.

The outer peripheral end 435, the inner peripheral end 436, the through-hole 433 for allowing the insertion of the fastening pin 44, and the through-hole 434 for allowing the insertion of the connecting bolt 46, each of which is a portion of the end plate 43a, are provided through processes in which a plate member 61, which is made of a metal material, is press formed in thickness directions. As FIG. 2 illustrates, a shear-droop, which serves as a rounded surface portion, is formed on the reverse side surface VS of the end plate 43a during press forming of each of the outer peripheral end 435 and the inner peripheral end 436. Another shear-droop is formed at an end 433a on the reverse side surface VS of the end plate 43a at the through-hole 433 for allowing the insertion of the fastening pin 44 during press forming of the through-hole 433. At the through-hole 434 for allowing the insertion of the connecting bolt 46 of the end plate 43a, a shear-droop formed during press forming of the through-hole 434 is formed at an end 434a on the side of the pressing surface PS.

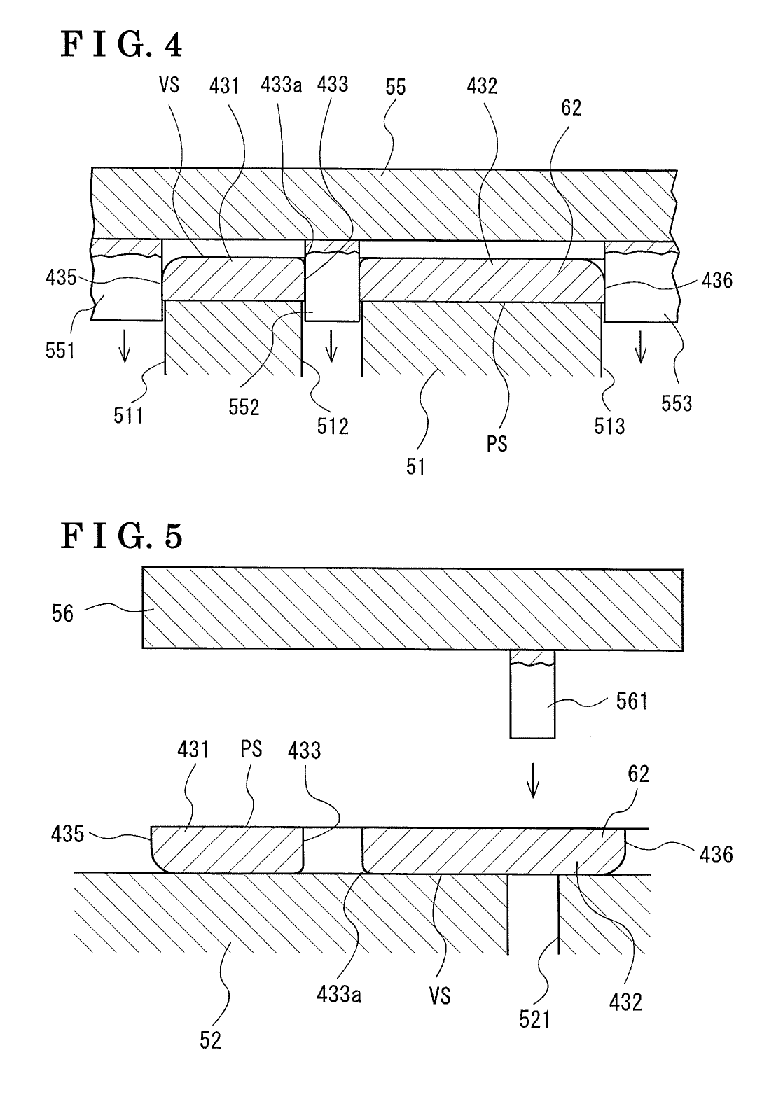

Processes for forming, or manufacturing, the end plate 43a will be described next referring to FIGS. 3 to 6. First, the plate member 61, which is made of a metal material, is placed on a die 51 for press forming external form, as FIG. 3 illustrates. The die 51 for press forming external form is equipped with an opening 511 for forming the outer peripheral end 435, an opening 512 for forming the through-hole 433 for allowing the insertion of the fastening pin 44, and an opening 513 for forming the inner peripheral end 436. The plate member 61, which is being placed on the die 51 for press forming external form, is press formed from an upward direction in FIG. 3, which serves as a first direction, with a punch 55 for forming external form equipped with a punching portion 551 for forming the outer peripheral end 435, a punching portion 552 for forming the through-hole 433 for allowing the insertion of the fastening pin 44, and a punching portion 553 for forming the inner peripheral end 436. The punching portion 551 for forming the outer peripheral end 435 is impacted into the opening 511 for forming the outer peripheral end 435. The punching portion 552 for forming the through-hole 433 for allowing the insertion of the fastening pin 44 is impacted into the opening 512 for forming the through-hole 433 for allowing the insertion of the fastening pin 44. The punching portion 553 for forming the inner peripheral end 436 is impacted into the opening 513 for forming the inner peripheral end 436. The punch 55 for forming external form press forms the plate member 61 so that the outer peripheral end 435, the through-hole 433 for allowing the insertion of the fastening pin 44, and the inner peripheral end 436 are formed simultaneously for providing an intermediate member 62 as FIG. 4 illustrates. During the press forming process using the punch 55 for forming external form, the shear-droop is formed on the surface that becomes the reverse side surface VS at the outer peripheral end 435, at the end 433a of the through-hole 433 for allowing the insertion of the fastening pin 44, and at the inner peripheral end 436.

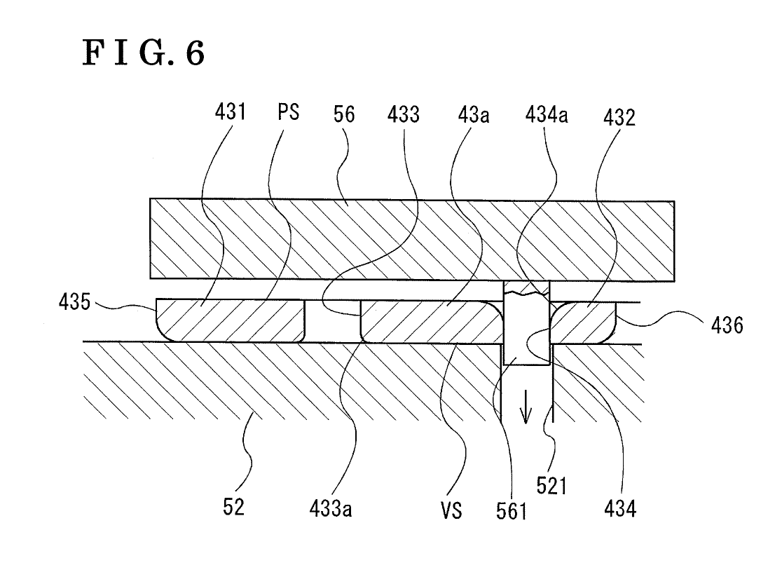

In the next process, as FIG. 5 illustrates, the intermediate member 62 is placed on a die 52 for press forming the through-hole 434 for allowing the insertion of the connecting bolt 46 with the surface the shear-droops are formed at the outer peripheral end 435 and other portions being faced downward. In other words, the intermediate member 62 is placed on the die 52 for press forming the through-hole 434 for allowing the insertion of the connecting bolt 46 with the reverse side surface VS facing the die 52 for press forming the through-hole 434 for allowing the insertion of the connecting bolt 46. By using a punch 56 for forming the through-hole 434 for allowing the insertion of the connecting bolt 46, which is equipped with a punching portion 561 for forming the through-hole 434 for allowing the insertion of the connecting bolt 46, the intermediate member 62 being placed on the die 52 for press forming the through-hole 434 is press formed from the opposite direction from which the outer peripheral end 435 and other portions are press formed. In other words, the intermediate member 62 is press formed from a direction from which the pressing surface PS is provided, the direction which serves as a second direction. The punching portion 561 of the punch 56 for forming the through-hole 434 for allowing the insertion of the connecting bolt 46 is impacted into an opening 521 for forming the through-hole 434 for allowing the insertion of the connecting bolt 46, so that the intermediate member 62 is press formed to form the through-hole 434 for allowing the insertion of the connecting bolt 46. As FIG. 6 illustrates, during the press forming process using the punch 56 for forming the through-hole 434 for allowing the insertion of the connecting bolt 46, the shear-droop is formed at the end 434a of the through-hole 434 for allowing the insertion of the connecting bolt 46. The end 434a is formed on the surface on the reverse side of the surface where the shear-droop is formed at the outer peripheral end 435, the inner peripheral end 436, and the through-hole 433 for allowing the insertion of the fastening pin 44. In other words, the end 434a is formed on the surface that becomes the pressing surface PS. The end plate 43b, an end plate that is not connected to the drum member 48, may be formed through a similar process for forming the end plate 43a, the processes illustrated in FIGS. 3 and 4. A plate member 61 for the end plate 43b may be press formed from the direction of a reverse side surface VS for providing the outer peripheral end 435, the inner peripheral end 436, and the through-hole 433 for allowing the insertion of the fastening pin 44.

According to the first embodiment of the rotor 4 for the electric motor 1, the through-hole 434 for allowing the insertion of the connecting bolt 46 is press formed from the opposite direction from which the outer peripheral end 435 of the end plate 43a is press formed. As a result, the shear-droop formed during the press forming of the outer peripheral end 435 is arranged on the reverse side surface VS of the end plate 43a, which is the surface on the reverse side of the surface configured to thrust the core body member 41, and the shear-droop formed during the press forming of the through-hole 434 for inserting a connecting bolt 46 is arranged on the pressing surface PS, which is the surface that thrusts the core body member 41.

As FIGS. 1 and 2 illustrate, formation of the shear-droop is avoided at the periphery of the through-hole 434 for allowing the insertion of the connecting bolt 46 on the end plate 43a, which is the periphery on the surface of the end plate 43a where the head portion 461 of the connecting bolt 46 applies thrust. Having no shear-droop on the surface of the end plate 43a where the head portion 461 of the connecting bolt applies thrust, the end plate 43a receives the thrust load from the connecting bolt 46 with larger surface area compared to when the shear-droop is present. A stress the end plate 43a receives may be reduced, which in turn prevents loosening of the connecting bolt 46 as a result of a deformation of the end plate 43a. Thus, the end plate 43a and the drum member 48 are rigidly connected.

Formation of the shear-droop is avoided at the outer peripheral end 435 of the end plate 43a on the surface where the outer peripheral end 435 thrusts the core body member 41. Accordingly, a reduction of the surface area for the core body member 41 to receive the thrust from the end plate 43a is avoided. As a result, the end plate 43a retains the core body member 41 rigidly regardless of the centrifugal force being generated by the rotation of the rotor 4. The inner peripheral end 436 of the end plate 43a is press formed from the same direction from which the outer peripheral end 435 is press formed when the plate member 61 is press formed. As a result, the shear-droop formed at the end 434a of the through-hole 434 for allowing the insertion of the connecting bolt 46 and the shear-droop formed at the inner peripheral end 436 are formed on surfaces on the opposite side to each other on the end plate 43a. A reduction of a thickness H indicated in FIG. 2, which is the thickness between the through-hole 434 for allowing the insertion of the connecting bolt 46 and the inner peripheral end 436, is avoided. As a result, a deformation of the end plate 43a is prevented regardless of the thrust applied from the head portion 461 of the connecting bolt 46.

The through-hole 433 for allowing the insertion of the fastening pin 44 is press formed from the same direction from which the outer peripheral end 435 of the end plate 43a is press formed when the plate member 61 is press formed. As a result, the shear-droop is formed at the end 433a of the through-hole 433 where the fastening pin 44 is riveted. In other words, the end 433a of the through-hole 433 for inserting the fastening pin 44 is without a protrusion, which is formed through press forming process of the through-hole 433 for allowing the insertion of the fastening pin 44. Accordingly, the fastening pin 44 is prevented from a riveting portion 441 being raised. In other words, a deformation of the riveting portion 441, which results in the riveting portion 441 to protrude along the protrusion formed at the end 433a, is prevented when the fastening pin 44 is riveted, which in turn prevents loosening of the fastening pin 44.

When the end plate 43a is press formed, the outer peripheral end 435, the inner peripheral end 436, and the through-hole 433 for allowing the insertion of the fastening pin 44 are press formed simultaneously. As a result, number of manufacturing processes for the end plate 43a is reduced and the cost of the electric motor 1 may be reduced. At the same time, when the end plate 43a is press formed, the outer peripheral end 435, the inner peripheral end 436, and the through-hole 433 for allowing the insertion of the fastening pin 44 are press formed simultaneously, an accuracy for providing relative positions between each portion may be improved.

A rotor 4 for an electric motor 1 according to other embodiments will be described next. The rotor 4 for the electric motor 1 according to the first embodiment may be modified or enhanced in following manners. Each of the end plate 43a and the end plate 43b may be provided with a similar structure so that each of the end plate 43a and the end plate 43b may be connected to the drum member 48. The end plate 43a and the drum member 48 may be connected by inserting the connecting bolt 46 through the end plate 43a, the drum member 48, and a nut or similar member in that order, and by tightening the connecting bolt 46 to the nut or similar member. When connecting the end plate 43a and the drum member 48, a washer, a collar, or similar member may be provided between the end plate 43a and the drum member 48.

When the end plate 43a or the end plate 43b is press formed, each of the outer peripheral end 435, the inner peripheral end 436, and the through-hole 433 for allowing the insertion of the fastening pin 44 may be formed through a separate process in consideration of a press forming procedure or for other reasons. The order for press forming the outer peripheral end 435, the inner peripheral end 436, and the through-hole 433 for allowing the insertion of the fastening pin 44 may be in any order of priority. The electric motor 1 according to any embodiments being disclosed here may be applied to a synchronous electric motor, an induction motor, a DC motor, or any other type of electric motor or electric rotating machine. The electric motor 1 according to any embodiments being disclosed here may be used for the purpose of an electric motor or an electricity generator.

According to an aspect of this disclosure, the rotor 4 for the electric motor 1 includes the core body member 41 formed with multiple number of steel sheets 42 for stacking being stacked one on top the other in the axial direction along the rotational axis C, the pair of end plates 43a, 43b sandwiching opposing ends of the core body member 41 in the direction which the core body member 41 is being stacked one on top the other and the drum member 48 connected to at least one of the end plates 43a, 43b. Said at least one of the end plates 43a, 43b includes a contact portion configured to thrust the core body member 41, a connecting portion extending from the contact portion toward the rotational axis C, the connecting portion provided with the through-hole 434 for allowing the insertion of the connecting bolt 46, the connecting bolt 46 that connects said at least one of the end plates 43a, 43b and the drum member 48, the pressing surface PS being continuous with the rounded surface portion formed during the process for forming the through-hole 434, and the reverse side surface VS being provided on a reverse side of the pressing surface PS. Said at least one of the end plates 43a, 43b is formed by press forming the plate member 61 in thickness directions, the first direction for forming the outer peripheral end 435 of said at least one of the end plates 43a, 43b and the second direction, the direction different from the first direction, for forming the through-hole 434 provided on said at least one of the end plates 43a, 43b. The pressing surface PS of said at least one of the end plates 43a, 43b faces the surface of the core body member 41 and the surface of the drum member 48, and the reverse side surface VS of said at least one of the end plates 43a, 43b makes contact with the surface of the connecting bolt 46.

By press forming the through-hole 434 for allowing the insertion of the connecting bolt 46 from the different direction from which the outer peripheral end 435 of the end plate 43a is press formed, the pressing surface PS with the shear-droop formed during the press forming of the through-hole 434 is arranged as the surface configured to thrust the core body member 41. Formation of the shear-droop is avoided at the periphery of the through-hole 434 for allowing the insertion of the connecting bolt 46 of the end plate 43a, the periphery on the surface of the end plate 43a where the head portion 461 of the connecting bolt 46 applies thrust. By having no shear-droop on the surface of the end plate 43a where the head portion 461 of the connecting bolt 46 applies thrust, the end plate 43a receives the thrust load from the connecting bolt 46 with larger surface area compared to when the shear-droop is present. As a result, the stress the end plate 43a receives may be reduced, which in turn prevents loosening of the connecting bolt 46 as the result of the deformation of the end plate 43a. Thus, the end plate 43a and the drum member 48 are rigidly connected. At the same time, formation of the shear-droop is avoided at the outer peripheral end 435 of the end plate 43a on the surface where the outer peripheral end 435 thrusts the core body member 41. The surface area the core body member 41 receives the thrust from the end plate 43a is prevented from being reduced. As a result, the end plate 43a retains the core body member 41 rigidly regardless of the centrifugal force being generated by the rotation of the rotor 4.

According to another aspect of this disclosure, the rotor 4 for the electric motor 1 is characterized by an inner peripheral end 436 of said at least one of the end plates 43a, 43b being formed by press forming the plate member 61 from the same direction for forming the outer peripheral end 435.

When the inner peripheral end 436 of said at least one of the end plates 43a, 43b configured to connect with the drum member 48 is press formed from the same direction from which the outer peripheral end 435 is press formed when the plate member 61 is press formed, the shear-droop formed at the end 434a of the through-hole 434 for allowing the insertion of the connecting bolt 46 and the shear-droop formed at the inner peripheral end 436 are arranged so that shear-droops are formed on the surfaces on the opposite side to each other on said at least one of the end plates 43a, 43b configured to connect with the drum member 48. The reduction of the thickness H between the through-hole 434 for allowing the insertion of the connecting bolt 46 and the inner peripheral end 436 is avoided. As a result, the deformation of said at least one of the end plates 43a, 43b configured to connect with the drum member 48 is prevented regardless of the thrust applied from the head portion 461 of the connecting bolt 46.

According to further aspect of this disclosure, the rotor 4 for the electric motor 1 is characterized by the contact portion of each of the pair of end plates 43a, 43b being provided with the through-hole 433 for allowing an insertion of a fastening pin 44. The core body member 41 and the end plates 43a, 43b are being retained together by inserting the fastening pin 44 through the core body member 41 and the through-hole 433 of each of the end plates 43a, 43b and by riveting the opposing ends of the fastening pin 44. The through-hole 433 is formed by press forming the plate member 61 from the same direction for forming the outer peripheral end 435.

When the through-hole 433 for allowing the insertion of the fastening pin 44 is press formed from the same direction from which the outer peripheral end 435 of each of the pair of end plates 43a, 43b is press formed when the plate member 61 is press formed, the shear-droop is formed at the end 433a of the through-hole 433 where the fastening pin 44 is riveted. The end 433a of the through-hole 433 for inserting the fastening pin is without the protrusion, which is formed during the press forming process of the through-hole 433 for allowing the insertion of the fastening pin 44. Accordingly, the fastening pin 44 is prevented from the riveting portion 441 being raised. In other words, the deformation of the riveting portion 441, which results in the riveting portion 441 to protrude along the protrusion formed at the end 433a of the through-hole 433 for allowing the insertion of the fastening pin 44, is prevented when the fastening pin 44 is riveted, which in turn prevents loosening of the fastening pin 44.

According to another aspect of this disclosure, the rotor 4 for the electric motor 1 is characterized by said at least one of the end plates 43a, 43b and the drum member 48 are connected by inserting the connecting bolt 46 through the through-hole 434 for allowing the insertion of the connecting bolt 46 and by tightening the connecting bolt 46 to the drum member 48 at the connecting portion 432 in the state where the pressing surface PS and the drum member 48 are arranged to face each other.

Said at least one of the end plates 43a, 43b and the drum member 48 are connected by inserting the connecting bolt 46 through the through-hole 434 for allowing the insertion of the connecting bolt 46 and by tightening the connecting bolt 46 to the drum member 48 at the connecting portion 432 in the state where the pressing surface PS and the drum member 48 are arranged to face each other. At the same time, the core body member 41 and the drum member 48 are arranged such that the core body member 41 and the drum member 48 are provided on the same surface of said at least one of the end plates 43a, 43b. By arranging the core body member 41 on the same surface where the drum member 48 is arranged to face said at least one of the end plates 43a, 43b, the procedure for tightening the connecting bolt 46 becomes easy due to the core body member 41 being out of the way of tightening the connecting bolt 46 when attaching the drum member 48 to said at least one of the end plates 43a, 43b.

According to further aspect of this disclosure, the method for forming the rotor 4 for the electric motor 1 includes the process of forming the core body member 41 by stacking multiple number of steel sheets 42 for stacking one on top the other in the axial direction along the rotational axis C. The method for forming the rotor 4 for the electric motor 1 also includes processes of forming of forming the intermediate member 62 by press forming the plate member 61 from the first direction for forming the through-hole 433 for allowing the insertion of the fastening pin 44 and forming at least one of end portions 43a, 43b including the rounded surface portion, and of forming at least one of the pair of end plates 43a, 43b, which includes the contact portion provided with the pressing surface PS configured to thrust the core body member 41 and includes the connecting portion extending toward the rotational axis C from the contact portion, the connecting portion provided with the through-hole 434, formed by forming the through-hole 434 for allowing the insertion of the connecting bolt 46 by press forming the intermediate member 62 from the second direction different from the first direction, the second direction which is the direction from the pressing surface PS provided on the reverse side of the reverse side surface VS, the reverse side surface VS continuous with the rounded surface portion. The method for forming the rotor 4 for the electric motor 1 further includes processes of connecting the core body member 41 and the end plates 43a, 43b by riveting the fastening pin 44 inserted through the through-hole 433 extending through each of the end plates 43a, 43b and through the core body member 41 in the state where the pressing surface PS thrusts the corresponding end surface of the core body member 41, and of connecting the core body member 41, the end plates 43a, 43b and the drum member 48 by inserting the connecting bolt 46 through the through-hole 434 in the state where the drum member 48 is in contact with the pressing surface PS of the connecting portion and by tightening the connecting bolt 46 thereat.

Accordingly, formation of the shear-droop is avoided at the periphery of the through-hole 434 for allowing the insertion of the connecting bolt 46 of the end plate 43a, the periphery on the surface of the end plate 43a where the head portion 461 of the connecting bolt 46 applies thrust. By having no shear-droop on the surface of the end plate 43a where the head portion 461 of the connecting bolt 46 applies thrust, the end plate 43a receives the thrust load from the connecting bolt 46 with larger surface area compared to when the shear-droop is present. As a result, the stress the end plate 43a receives may be reduced, which in turn prevents loosening of the connecting bolt 46 as the result of the deformation of the end plate 43a. Thus, the end plate 43a and the drum member 48 are rigidly connected.

According to another aspect of this disclosure, the method for forming the rotor 4 for the electric motor 1 is characterized by said at least one of the end plates 43a, 43b formed in the annular form and the ends 435, 436 of said at least one of the end plates 43a, 43b define the inner peripheral end 436 and the outer peripheral end 435.

Accordingly, formation of the shear-droop is avoided at the outer peripheral end 435 of said at least one of the end plates 43a, 43b on the surface where the outer peripheral end 435 thrusts the core body member 41. By avoiding the reduction of the surface area the core body member 41 receives the thrust from said at least one of the end plates 43a, 43b, said at least one of the end plates 43a, 43b retains the core body member 41 rigidly regardless of the centrifugal force being generated by the rotation of the rotor 4. At the same time, the shear-droop formed at the end 434a of the through-hole 434 for allowing the insertion of the connecting bolt 46 and the shear-droop formed at the inner peripheral end 436 are arranged so that shear-droops are formed on the surfaces on the opposite side to each other on said at least one of the end plates 43a, 43b configured to connect with the drum member 48. By avoiding the reduction of the thickness H between the through-hole 434 for allowing the insertion of the connecting bolt 46 and the inner peripheral end 436, the deformation of said at least one of the end plates 43a, 43b configured to connect with the drum member 48 is prevented regardless of the thrust applied from the head portion 461 of the connecting bolt 46.

According to further aspect of this disclosure, the method for forming the rotor 4 for the electric motor 1 is characterized by the inner peripheral end 436 and the outer peripheral end 435 of said at least one of end plates 43a, 43b being simultaneously press formed from the same direction.

When the outer peripheral end 435 and the inner peripheral end 436 of said at least one of the end plates 43a, 43b configured to connect with the drum member 48 are press formed simultaneously when the plate member 61 is press formed, number of manufacturing processes for said at least one of the end plates 43a, 43b configured to connect with the drum member 48 is reduced and the cost of the rotor 4 may be reduced. Also, when the outer peripheral end 435 and the inner peripheral end 436 of the end plate 43a configured to connect with the drum member 48 are press formed simultaneously when the plate member 61 is press formed, the accuracy for providing relative positions between each portion may be improved. When the outer peripheral end 435 and the inner peripheral end 436 of the end plate 43a configured to connect with the drum member 48 are press formed from the same direction when the plate member 61 is press formed, the shear-droop formed at the end 434a of the through-hole 434 for allowing the insertion of the connecting bolt 46 and the shear-droop formed at the inner peripheral end 436 are arranged so that shear-droops are formed on the surfaces on the opposite side to each other on said at least one of the end plates 43a, 43b configured to connect with the drum member 48. By avoiding the reduction of the thickness H between the through-hole 434 for allowing the insertion of the connecting bolt 46 and the inner peripheral end 436, the deformation of said at least one of the end plates 43a, 43b configured to connect with the drum member 48 is prevented regardless of the thrust applied from the head portion 461 of the connecting bolt 46.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A rotor for an electric rotating machine, comprising:
a core body member formed with a plurality of core plates being stacked one on top the other in an axial direction along a rotational axis;
a pair of end plates sandwiching opposing ends of the core body member in the direction which the core body member is being stacked one on top the other; and
an output member connected to at least one of the end plates, wherein
said at least one of the end plates includes a contact portion configured to thrust the core body member, a connecting portion extending from the contact portion toward the rotational axis, the connecting portion provided with a first through-hole for allowing an insertion of a connecting member, the connecting member that connects said at least one of the end plates and the output member, a first surface being continuous with a rounded surface portion formed during a process for forming the first through-hole, and a second surface being provided on a reverse side of the first surface, and wherein
said at least one of the end plates is formed by press forming a plate member in thickness directions, a first direction for forming an outer peripheral end portion of said at least one of the end plates and a second direction, the direction different from the first direction, for forming the first through-hole provided on said at least one of the end plates, and wherein
the first surface of said at least one of the end plates faces a surface of the core body member and a surface of the output member, and the second surface of said at least one of the end plates makes contact with a surface of the connecting member.

2. The rotor for the electric rotating machine according to claim 1, wherein an inner peripheral end portion of said at least one of the end plates is formed by press forming the plate member from the same direction for press forming the outer peripheral end portion.

3. The rotor for the electric rotating machine according to claim 1, wherein
the contact portion of each of the pair of end plates is provided with a second through-hole for allowing an insertion of a fastening pin, and wherein
the core body member and the end plates are being retained together by inserting the fastening pin through the core body member and the second through-hole of each of the end plates and by riveting the opposing ends of the fastening pin, and wherein
the second through-hole is formed by press forming the plate member from the same direction for forming the outer peripheral end portion.

4. The rotor for the electric rotating machine according to claim 2, wherein said at least one of the end plates and the output member are connected by inserting the connecting member through the first through-hole for allowing the insertion of the connecting member and by tightening the connecting member to the output member at the connecting portion in a state where the first surface and the output member are arranged to face each other.

5. A method for manufacturing a rotor for an electric rotating machine comprising processes of:
forming a core body member by stacking a plurality of core plates one on top the other in an axial direction along a rotational axis;
forming an intermediate member by press forming a plate member from a first direction for forming a second through-hole for allowing an insertion of a fastening pin and forming at least one of end portions including a rounded surface portion;
forming at least one of a pair of end plates, the end plate including a contact portion provided with a first surface configured to thrust the core body member and including a connecting portion extending toward the rotational axis from the contact portion and provided with a first through-hole for allowing an insertion of a connecting member, formed by forming the first through-hole by press forming the intermediate member from a second direction different from the first direction, the second direction which is the direction from the first surface provided on the reverse side of a second surface, the second surface continuous with the rounded surface portion;
connecting the core body member and the end plates by riveting the fastening pin inserted through the second through-hole extending through each of the end plates and through the core body member in a state where the first surface thrusts a corresponding end surface of the core body member; and
connecting the core body member, the end plates and the output member by inserting the connecting member through the first through-hole in a state where the output member is in contact with the first surface of the connecting portion and by tightening the connecting member thereat.

6. The method for manufacturing the rotor for the electric rotating machine according to claim 5, wherein said at least one of the end plates is in an annular form and the end portions of said at least one of the end plates define an inner peripheral end portion and an outer peripheral end portion.

7. The method for manufacturing the rotor for the electric rotating machine according to claim 6, wherein the inner peripheral end portion and the outer peripheral end portion of said at least one of the end plates are simultaneously press formed from the same direction.
